(19) United States
(12) Patent Application Publication
(10) Pub. No.: US 2020/0084213 A1
(43) Pub. Date: Mar. 12, 2020

(54) LOW-LATENCY DIFFERENTIAL ACCESS CONTROLS IN A TIME-SERIES PREDICTION SYSTEM

(71) Applicant: Google LLC, Mountain View, CA (US)

(72) Inventor: Emanuel Taropa, San Jose, CA (US)

(21) Appl. No.: 16/124,586

(22) Filed: Sep. 7, 2018

(51) Int. Cl. H04L 29/06; G06F 17/30

(52) U.S. Cl. CPC H04L 63/10; G06F 17/30011

(57) ABSTRACT

Methods, systems, and apparatus, including computer programs encoded on computer storage media, for implementing low-latency differential access controls in a distributed prediction system. One of the methods includes obtaining, by a root server from an authorization server, one or more permitted action types for a requester. A plurality of predicted actions that each co-occur in at least one document with a search parameter are obtained. Any actions having an action type that is not one of the one or more permitted action types for the requester is filtered from the plurality of predicted actions. One or more predicted actions having one of the permitted action types is provided to the requester.

### BACKGROUND

This specification relates to large-scale, low-latency, distributed computer systems, and more particularly to using distributed computer systems to search large collections of data to generate real-time predictions of time-correlated user actions.

A time-series prediction system, or for brevity, a prediction system, is a distributed computer system that predicts user actions based on large-scale aggregations of time-series data. This allows time-correlated actions to be discovered and ranked by likelihood in real time. Such prediction systems can be used for a wide variety of practical applications. One example application is query suggestions. For example, given a previous query entered by a user of a search engine, a prediction system can predict a next query that the user wants to enter by discovering and ranking previous queries entered in large numbers by other users that were time-correlated with the previous query. For example, if a user enters a first query, “newborn clothes,” a prediction system can predict that the next query is likely to be “baby cribs” because a significant amount of previous users had entered these two queries close together in time. Thus, the system can provide, “baby cribs,” as a query suggestion for a user who enters “newborn clothes” as a query. Importantly, a prediction system can compute such predictions in an online fashion and in real-time, e.g., after the query is received and with no discernible latency from the user's perspective. As a result, extreme low-latency is critical for most operations of a real-time prediction system.

In this specification, time-series data means data representing that particular groups of actions by a single particular user co-occurred during a particular short time period. The length of the short time period is a system-tunable parameter, and which is typically on the order of minutes, hours, or days, rather than months or years. A prediction system can associate data representing user actions of a single user that co-occurred during a particular time period in a number of different ways. For example, the system can generate a single document that includes data representing all actions that co-occurred during a single time period. These techniques also allow a prediction system to discover time-correlated user actions without regard to the order in which the actions actually occurred.

In order to make such predictions in real time, a prediction system can use a distributed computer system to query an inverted index in parallel. The inverted index associates each user action with documents having at least one instance of the user action. For example, the prediction system can be arranged in a tree-based hierarchy with a root server, multiple intermediate servers in one or more levels, and multiple leaf servers. This arrangement allows the collection of indexed data to be searched in real-time, which is important because the space of searchable parameters prevents a complete index from being pregenerated.

Privacy and anonymity are other important aspects of a prediction system that searches documents that each store time-correlated data for a single respective user. In order to ensure user privacy and anonymity, a prediction system can have built-in privacy mechanisms that ensure that a particular user action is only returned if the user action was performed by at least a threshold number of other users. In this specification, the threshold will be referred to as the privacy threshold. Thus, if the privacy threshold is 100 users and if only 88 other users performed a particular action, the system will decline to provide the particular action because the particular action fails to meet the privacy threshold. This mechanism prevents highly-individualized user data from leaking out to other users. Suitable techniques for quickly computing an estimated number of users for a particular action are described in commonly-owned U.S. patent application Ser. No. 15/277,306, for “Generalized Engine for Predicting Actions,” which is herein incorporated by reference.

Large-scale prediction systems present inherent scalability challenges, particularly when used for applications having extreme low-latency requirements, e.g., providing online query suggestions. These scalability challenges grow both as an organization gets larger and as the amount of underlying data gets larger.

One particular scalability problem for large-scale prediction systems is access controls, meaning controlling which groups or entities within an organization have permissions to query or access the underlying data. Even when a single organization has complete control over all the underlying data, allowing all internal teams to query for all available data does not follow the principle of least privilege.

However, enforcing access controls on the underlying data itself can introduce unacceptable latency. For example, this could require all of the leaf servers to communicate with an external authorization system for every query or every document or both. This is because fundamental security principles require that any membership or permissions change to any recognized group or entity should be implemented as immediately as possible to prevent unauthorized access. Therefore, storing authorization information on the leaf servers is not possible because such permissions updates would take too long when there are thousands of leaf servers to be updated. But having leaf servers communicate with an external authorization system introduces unacceptable latency into the process, particularly when there are thousands of leaf servers that need to serve thousands of requests per second. For example, if there are 1000 leaf servers that need to analyze 1000 actions per query and to serve 1000 requests per second, the authorization system itself would need to field 1 billion requests every second, which is not feasible for real-time applications because it introduces unacceptable latency into the process.

### SUMMARY

This specification describes techniques for implementing low-latency differential access controls in a prediction system that uses typed, time-series data. This means that a prediction system controls different levels of access for different requesting entities or groups in a way that does not appreciably degrade the latency of the prediction system.

Particular embodiments of the subject matter described in this specification can be implemented so as to realize one or more of the following advantages. A prediction system can enforce differential access controls for an arbitrary number of entities or groups on an arbitrarily large dataset without incurring a significant degradation in system latency. The differential access controls are therefore scalable for increasing datasets and increasing organization sizes. A prediction system can further use caching to reduce the latency of enforcing differential access controls. Thus, even when serving hundreds or thousands of queries per second, providing differential access controls has an almost unmeasurable impact on system latency. The techniques described below also reduce storage redundancy by allowing the prediction system to maintain a single dataset for all requesters rather than having to manage multiple redundant datasets for multiple groups.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram that illustrates an example system.

FIG. 2 is a flowchart of an example process for enforcing access controls on action types by a prediction system.

Like reference numbers and designations in the various drawings indicate like elements.

### DETAILED DESCRIPTION

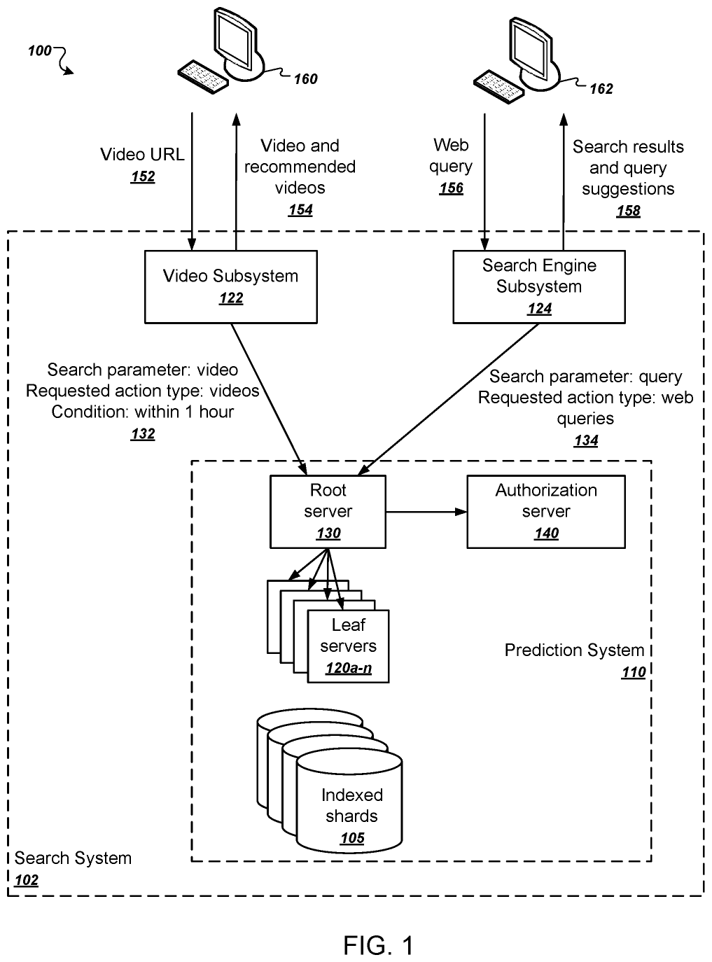

FIG. 1 is a diagram that illustrates an example system 100. The system 100 includes an example search system 102, which is an example of a system that uses a prediction system 110 to make real-time predictions from typed, time-series data. In this example, the search system 102 uses the prediction system 110 to make predictions for an online video subsystem 122 and a search engine subsystem 124. However, the same techniques described below can also be used for other prediction systems that do not augment the search capabilities described with relation to the search system 102.

In this specification, typed data means that some user actions belong to one of a plurality of different action types. For example, a prediction system can consider queries as one action type, web page visits to be another action type, and video views as yet another action type. The action types need not be mutually exclusive. For example, visiting a webpage with an embedded video can be considered both a web page visit action and a video viewing action. The documents searched by a prediction system typically have multiple different types of user actions. For example, a document can indicate that a particular user entered a query, then visited a website, and then watched a video, all within a particular time period. The time-correlated actions having different types allows a prediction system to make aggregate cross-type predictions. Therefore, for example, a prediction system can determine which queries users are likely to enter after watching a particular video.

A prediction system can associate data representing user actions of a single user that co-occurred during a particular time period in a number of different ways. For example, the system can generate a single document that includes data representing all actions that co-occurred during a single time period. The document can be a record in a database, an in-memory object, or an electronic document, which may, but need not, correspond to a file in a file system. In this specification, for brevity a document will refer broadly to data representing such an association of time-correlated user actions by a single user.

For brevity, this specification includes various examples that describe performing operations on actions. Such examples are to be understood as operating on data representing such user actions. Each distinct user action, for example, can be represented with a unique identifier. In addition, different actions performed by different users at different times can be considered the same action if mapped to the same unique identifier. For example, a first user submitting a query for “basketball” will be considered the same action as a second user later submitting the same query.

A prediction system can use data representing many different types of user actions. In general, an action can be data representing any appropriate action performed by a user, or on behalf of a user, on any interactive system, e.g., a web search system, an image search system, a map system, an e-mail system, a social network system, a blogging system, a shopping system, just to name a few. An action can also represent an event related to a user, e.g., a receipt of an e-mail message, or a higher level task. A user action can be, for example, the submission of a particular query; the selection, in response to a particular query, of a particular search result, or of any search result; a visit, or a long visit, to a particular web site, page, or image; the viewing of a video; the submission of a request for directions to a point of interest; the receipt of a message confirming a hotel, flight, or restaurant reservation, or confirming purchase of a particular product or kind of product, or of a particular service or kind of service; or the purchase of a particular product or service.

A document can include further information about each action, for example, a location, a time of day, a day of week, a date, or a season of the action, for example. The location can be obtained from a location obtained from a user device used to interact with the interactive system or from a service provider, e.g., a mobile telephone network, or it can be inferred, for example, from an IP address of the user device. The location can be recorded in a generalized form using identifiers of one or more quadrilaterals in a predetermined geographic grid.

In some cases, actions can be associated with entities, in particular, with real world people, places, things, both tangible and intangible. For example, a search system could determine that a particular query is about a particular city, and the prediction system could then associate a globally unique identifier for the city with the query in the document. Similarly, a shopping system or an e-mail system could determine that a user has purchased a particular product or service, associate that with a particular entity and a unique identifier for the product or service entity, and include that information in the corresponding activity record. The entities associated with the activities of a user can be treated as likely interests of the user at the time of the activity.

In the FIG. 1 example, the video subsystem 122 is an online system that serves videos to external user devices over a computer network, e.g., an intranet or the Internet. For example, an external user device 160 can provide a request for a video URL 152 to the video subsystem 122. The video subsystem 122 can then use the requested video URL 152 to obtain recommended videos from the prediction system 110. The video subsystem 122 can then provide the requested video and one or more recommended videos 154 in response to receiving the video URL 152.

In this context, the recommended videos can be videos that the prediction system 110 has determined to be most likely to co-occur in documents with the requested video URL 152. As described above, a particular video co-occurring with the search parameter means that within a particular time period, a single anonymized user viewed both the video URL 152 and the co-occurring video.

Thus, the video subsystem 122 can provide a query 132 to the root server 130 that specifies a search parameter, a requested action type, and optionally one or more conditions. In the example of FIG. 1, the search parameter is the video URL 152 from the requesting user, and the requested action type is viewed videos or an identifier representing this action type. In this example, the query 132 also includes an optional condition specifying that the search parameter and the requested action type must have occurred within one hour of each other in the underlying documents.

To respond to the query 132, the root server 130 broadcasts the query 132 to a plurality of leaf servers 120a-n. In some implementations, the prediction system 110 also includes one or more levels of intermediate servers between the root server 130 and the leaf servers 120a-n.

The leaf servers 120a-n then search respective indexed shards 105 to first identify documents having the requested video URL. In general, the indexed shards 105 each store indexed documents. To perform parallel searching, the prediction system can store multiple shards of indexed data across multiple respective leaf servers, with each shard being one portion of the entire dataset. A shard can be one partition in a set of non-overlapping partitions, although a shard can also or alternatively be duplicated among multiple servers. Each server in the system can have multiple replicas. Thus, a same shard of indexed data can be assigned to a pool of multiple leaf servers. Each pool of leaf servers handles queries directed to the associated shard so that the index data can be searched in parallel over the shards.

The leaf servers 120a-n then compute scores for all other video watching actions that co-occur in the documents and compute a respective initial score for each of the co-occurring video views that is based on how frequently each of the video views was observed to co-occur in documents with the requested video URL 152.

The leaf servers 120a-n also compute, for each co-occurring video, a measure of how many distinct users are represented by the co-occurring video. The prediction system 110 computes the user counts so that the root server 130 can ensure that any recommended video provided back to the end user is a video that satisfies the corresponding privacy threshold. The leaf servers 120a-n provide all the co-occurring videos, scores, and user counts back to the root server 130.

The root server 130 can then aggregate the scores and user counts for each video. Then, assuming that the requested action type is authorized for the video subsystem 122, the root server 130 can respond to the query 132 with one or more videos having a user count that satisfies the privacy threshold, along with their respective scores. In some implementations, the root server 130 responds with a probability distribution for each of one or more videos that satisfies the privacy threshold.

In a similar manner, the search engine subsystem 124 can also use the prediction system 110 to augment the data it provides to users. Even though the function of a search engine is very different from the function of a video serving subsystem, both systems can use the same general-purpose prediction system 110.

The search engine subsystem 124 can thus receive a web query 156 from an external user device 162 and can respond to the web query 156 with search results and query suggestions 158.

To obtain the query suggestions, the search engine subsystem can provide a query 134 to the root server 130. The query 134 in this example has a search parameter specifying the web query 156 received from the external user device 162. The query 134 also specifies a requested action type, which in this case are other web queries. The query 134 thus requests, from the prediction system 110, other web queries that are the most likely to co-occur in documents with the web query 156 received from the external user device 162.

The root server 130 can then communicate with the leaf servers 120a-n in a similar manner as described above to identify the web queries that are most likely to co-occur in documents with the web query 156. As described above, a particular web query co-occurring with the search parameter means that within a particular time period, a single anonymized user issued both the web query and also the particular web query. Then, assuming that the requested action type is authorized for the search engine subsystem 124, the root server 130 can respond to the query 134 with one or more query suggestions having a user count that satisfies the privacy threshold, along with their respective scores. The search engine subsystem 124 can then respond to the web query 156 with search results obtained by the search engine subsystem 124 and also with query suggestions obtained from the prediction system 110.

As illustrated by this example, the prediction system 110 computes predictions in real-time and in an online fashion for multiple different requesting subsystems. In this context, computing predictions in real time means that an end user would observe no appreciable delays due to computer processing limitations. In other words, the predictions can be computed on the order of milliseconds rather than seconds, minutes, or longer.

The prediction system 110 can enforce access controls with minimal impact on latency by having the root server perform authorization checks on the requested action types using an authorization server. This reduces latency because the many leaf servers 120a-n do not need to perform authorization checks. Rather, the root server 130 can perform a single authorization check for each query.

In addition, the root server 130 can perform very fast authorization checks by enforcing authorization by action type. In other words, the authorization server 130 can map a requester identifier to a set of permitted action types, and the root server 130 only responds to the requester with predicted actions having a permitted action type. The number of action types is likely to be minuscule compared to the number of documents in the indexed shards 105. Therefore, only a small amount of data needs to be communicated from the authorization server 140 to the root server 130.

The root server 130 can further speed up the computation by performing the authorization check in parallel with computing the result. In other words, the root server 130 need not wait for the authorization server 140 to respond before broadcasting the query to the leaf servers 120a-n. Instead, the root server 130 can simply filter out actions that do not have a permitted action type before responding to a query.

In FIG. 1, for example, the principle of least privilege would specify that the video subsystem serving recommended videos would need to have access only to actions corresponding to video views, but not to other action types, e.g., query submissions, selections of web search results, or requests for driving directions, to name just a few examples. Similarly, the search engine subsystem 124 would need access only to actions corresponding to submitted queries, but not to other action types, e.g., video views. The root server 130 can efficiently enforce such access controls by using the authorization server 140 to control which action types are permitted for each of the requesting subsystems.

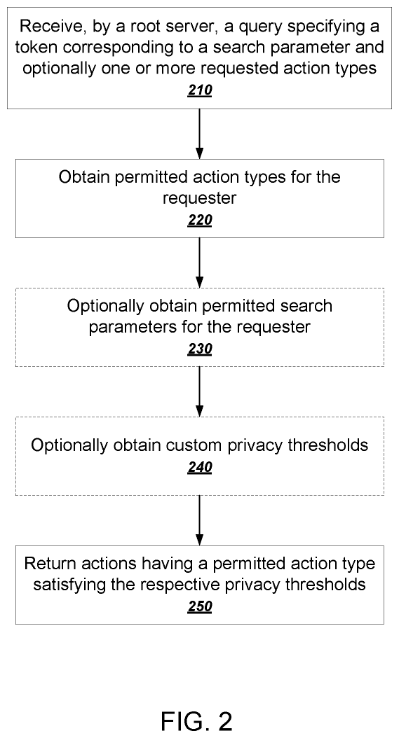

FIG. 2 is a flowchart of an example process for enforcing access controls on action types by a prediction system. For convenience, the process will be described as being performed by a system of one or more computers, located in one or more locations, and programmed appropriately in accordance with this specification. For example, a prediction system, e.g., the prediction system 110 of FIG. 1, appropriately programmed, can perform the example process.

The system receives, at a root server, a query specifying a token and optionally one or more requested action types (210). The action types are described as optional because in the absence of specified action types, the system can use a default action type and simply return all available action types that meet the appropriate privacy threshold.

The token is a unique identifier of a searchable parameter in the inverted index. The token can be specified explicitly by the query itself or implicitly by specifying the corresponding search parameter, which the root server can map to a particular token.

Each searchable parameter can specify any appropriate attribute relating to a document. Thus, the inverted index can associate each unique token with every document having the corresponding searchable parameter. For example, a token can correspond to a specific user action or to an attribute of a user associated with a document. For example, the token can represent the query “green bay packers.” A token can also represent location data, e.g., GPS coordinates, or the name or identifier of a particular place or region, e.g., Milwaukee, Wis. A token can also represent an attribute of a user, e.g., users who have identified themselves as liking or as being fans of the Green Bay Packers football team.

For example, the inverted index can thus have a unique token representing the query “green bay packers” and can associate with the unique token all documents having an occurrence of a user submitting the query “green bay packers.”

The system obtains permitted action types for the requester (220). The permitted action types are the action types that are allowed to be returned for the requester. In general, the permitted action types are based on the requesting entity or group that submitted the query. Thus, in some implementations, every query is associated with an requester identifier that uniquely distinguishes the entity or group from other entities or groups submitting queries.

To obtain the permitted action types, the root server can send a request for permitted action types to an authorization server that maintains a mapping between requester identifiers and permitted action types. For example, the root server can send a request to the authorization server that specifies the requester identifier “query-suggest” of internal team responsible for serving query suggestions.

The authorization server can respond with zero or more permitted action types for the requester identifier. The root server can then run the query if there is at least one permitted action type for the requester. Conversely, the root server can decline to perform a search or abort a search in progress if there are no permitted action types for the requester identifier. In addition, the root server can also decline to perform a search if the query specified a requested action type and the authorization server indicates that the requested action type is not a permitted action type.

Alternatively, the root server can perform a search using the query while waiting for the response from the authorization server because in a system designed for low-latency, executing the query is often faster than waiting for a response from an authorization server. The root server can then filter out any action types that are not permitted action types for the requester.

In some implementations, the permitted action types are also based on a query stream identifier that distinguishes different applications for the same requester. For example, the team having the requester identifier of “query-suggest” can be responsible for both query suggestions for video search as well as query suggestions for image search. In that case, the permitted action types for video search might be only video search queries but not image search queries. Conversely, the permitted action types for image search might be only image search queries but not video search queries. Therefore, each query from the query suggest team that requests video search queries can include a unique query stream identifier indicating the intended application for the predicted video search queries. Similarly, each query from the same query suggest team that requests image search queries can include a different unique query stream identifier indicating the application for the predicted image search queries.

Thus, when requesting the permitted action types from the authorization server, the root server can also optionally specify a query stream identifier in addition to a requester identifier.

The system can further reduce the latency of authorization checks by using an authorization cache. The authorization cache maps requester identifiers, and optionally query stream identifiers, to permitted action types. Thus, after receiving a request from the authorization server, the root server can add an entry to the authorization cache indicating that a particular requester identifier, and optionally a query stream identifier, was mapped by the authorization server to a particular set of action types.

The system can invalidate cache entries in a number of different ways. For example, the system can use an age-based eviction policy in order to periodically invalidate cache entries in order to force full authorization checks with the authorization server. For example, the entries in the authorization cache can bet set to expire after a short time period, e.g., 10 seconds, 30 seconds, 1 minute, or 10 minutes. In some implementations, the expiration time is additional information provided by the authorization server. For example, the authorization server can return shorter expiration times for more sensitive data. Alternatively or in addition, the system can use a default expiration time for the authorization cache, e.g., when the authorization server does not provide an expiration time. Thus, if the age of a cache entry is less than the expiration time, the system can determine that the cache entry is valid.

In some implementations, the system caches the entries at the user level. Thus, if a request is received from a different user in the same requesting group of a cached entry, the root server can still perform a full authentication check in order to ensure that the user is permitted to access the requested action types.

Using the authorization cache can dramatically reduce the latency compared to performing full-authorization checks with only a minimal risk to permissions changes. For example, if the root server responds to a thousand queries per second, and the default expiration time is 30 seconds, the root server will end up serving upwards of 30,000 requests with no measurable latency degradation due to using the cache for authorization checks.

The authorization server can also specify a sampling rate that represents after how many queries the root server must perform a full authorization check, regardless of the age of an entry in the authorization cache. In other words, the sampling rate indicates a maximum number of times that an entry in the authorization cache can be used for a particular requester.

The system optionally obtains permitted search tokens for the requester (230). In addition to permitted action types, the authorization server can also provide permitted search tokens for a requester identifier and optionally also a query stream identifier. Thus, if the provided search token is not among the permitted search tokens, the root server can decline to provide any predicted actions or decline to provide a response at all. For example, the system can restrict the US-based teams to providing US-based locations as search tokens and can restrict Europe-based teams to providing Europe-based locations as search tokens.

The system optionally obtains one or more custom privacy thresholds (240). As described above, a privacy threshold is a minimum number of distinct users that have to have performed a particular action before the action is returned in a response by the root server. The privacy threshold therefore ensures that individualized private data does not leak out to other users.

The authorization server can use a default privacy threshold for all action types. Alternatively or in addition, the authorization server can maintain different respective privacy threshold for each of one or more action types.

In addition, the authorization server can use different privacy thresholds depending on the requester, the query stream, or both. For example, the authorization server can maintain a mapping between each action type, requester identifier, and optionally, query stream identifier combination and a corresponding privacy threshold. For example, the authorization server can map each {query_stream, action_type, requester_id} tuple to a particular privacy threshold for that tuple.

The root server can then enforce the custom privacy thresholds when determining which actions to return in response to a query.

The system returns actions having a permitted action type satisfying the respective privacy thresholds (250). As described above, the root server can broadcast the search token to all leaf servers, optionally through one or more layers of intermediate servers. The leaf servers can then use the inverted index to identify actions that co-occur in documents having the search parameter corresponding to the token.

In order to enforce the restrictions on permitted action types, the root server can also specify to the leaf servers which action types are permitted and the leaf servers can then enforce the restrictions by identifying only actions belonging to the permitted action types.

Alternatively, the leaf servers can simply return all actions having any action type and the root server can perform filtering on non-permitted action types returned by the leaf servers. This approach is often faster because it requires the root server to convey less information to the leaf servers and requires the leaf servers to perform simpler logic in order to identify actions.

The leaf servers search their respective shards of the inverted index. For example, the inverted index can be arranged using a respective posting lists for each uniquely identifiable search token. Each posting list for a search token can include all documents that have the corresponding search parameter. The leaf servers can identify the posting list for the search token and scan the posting list to compute respective counts of co-occurring actions in the documents as well as a respective user count for each action. If the query specifies a requested action type, the leaf servers can scan the posting list only for documents having actions of the requested action type. The leaf servers can then provide the discovered actions and computed counts to the server in the next-highest level in the tree-based hierarchy, which can be an intermediate server or the root server.

The root server receives the co-occurring actions from the leaf servers or the last level of any intermediate servers, along with respective user counts that represent a measure of how many distinct users performed for each action. In some implementations, the system speeds up computation by computing a lower bound of the user count rather than an exact value.

The root server can then compute scores for the actions and return a score distribution for actions that have permitted action types and that satisfy the privacy threshold. In some implementations, the root server also imposes a score threshold by returning only actions that also have a score that satisfies a score threshold.

In order to further reduce latency, the root server can first filter out action types before computing scores for the actions. The root server can filter out actions that do not have a permitted action type according to the permitted action types received from the authorization server. This can mean, for example, that a same document obtained for the same query can result in the root server responding with different actions depending on the requester. The root server can also filter out actions that do not have a user count satisfying the privacy threshold for the action. The root server can perform these filtering operations in any appropriate order or concurrently.

To compute the score for an action, the root server can use statistics computed by the leaf servers and possibly aggregated intermediate servers. The leaf servers can compute counts of how many times each action was observed to co-occur with the reference parameter and how many times each action occurred in general. The root server can then aggregate these counts in order to compute a final respective score for each action.

In general, the score for an action given a search parameter represents the comparative significance of the action co-occurring in a document having the search parameter versus the action occurring in any document. For example, the score for an action can represent a likelihood of the action occurring in an indexed document having the search parameter P(action|search_parameter) compared to the general likelihood of the event occurring in all documents P(action). When the inference system stores event data in documents, the inference system may estimate P(action|search_parameter) by dividing (1) a count of indexed documents that include the particular action and the search parameter by (2) a count of indexed documents that include the particular action. The system can estimate P(action) by dividing (1) a count of documents that include the action by (2) a count of indexed documents in the dataset. The root server can then compute a final score S for an action as:

S=P(action|search_parameter)/P(action).

The root server can rank the actions by the computed scores and can provide a ranked set of actions in response to the query. As described above, the non-permitted action types and action types that do not satisfy the privacy threshold have been filtered out, and thus are not returned to the requester.

Although the above-techniques have been described in the context of differential privacy for a low-latency prediction system, the same techniques can be used to apply low-latency differential privacy controls for searching within in any system that has the notion of documents or the contents therein belonging to different respective entities, e.g., entities in an organization.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:

receiving, from a requester by a root server of a prediction system, a query specifying a token corresponding to a search parameter, the query being a request for the prediction system to compute user actions that are most likely to co-occur in documents with the search parameter, each document comprising data representing actions performed by a single respective user during a particular time period;

obtaining, by the root server from an authorization server, one or more permitted action types for the requester;

obtaining, by the root server, a plurality of predicted actions that each co-occur in at least one document with the search parameter, including:
providing, by the root server, the token to each of a plurality of leaf servers,
searching, by each leaf server, documents assigned to the leaf server that have the search parameter corresponding to the token to determine one or more actions that co-occur with the search parameter in the documents having the search parameter, and
providing, by each leaf server to the root server, the one or more actions that co-occur in documents having the search parameter;

filtering, from the plurality of predicted actions, any actions having an action type that is not one of the one or more permitted action types for the requester; and

providing, to the requester in response to the query, one or more predicted actions having one of the permitted action types.

Embodiment 2 is the method of embodiment 1, wherein obtaining, by the root server, the plurality of predicted actions that each co-occur in at least one document with the search parameter is performed at least partially concurrently with obtaining, from the authorization server, the one or more permitted action types for the requester.

Embodiment 3 is method of any one of embodiments 1-2, wherein obtaining, by the root server from an authorization server, one or more permitted action types for the requester comprises:

maintaining, by the authorization server, a mapping between requester identifiers and permitted action types; and

obtaining the one or more permitted action types by using a requester identifier for the requester as input to the mapping.

Embodiment 4 is the method of embodiment 3, wherein the mapping is further based on a query stream identifier that distinguishes different applications of the predicted actions for the same requester.

Embodiment 5 is the method of any one of embodiments 1-4, further comprising:

receiving, from a second requester by the root server, a second query specifying a requested action type;

obtaining, by the root server from the authorization server, one or more permitted action types for the second requester;

determining, by the root server, that the requested action type is not among the one or more permitted action types; and

in response, declining to return predicted actions in response to the second query.

Embodiment 6 is the method of any one of embodiments 1-5, further comprising:

receiving, from a second requester by the root server, a second query specifying a requested action type;

obtaining, by the root server from the authorization server, an indication that the second requester has no permitted action types; and

in response, declining to return predicted actions in response to the second query.

Embodiment 7 is the method of any one of embodiments 1-6, further comprising:

receiving, from a second requester by the root server, a second query specifying a second token corresponding to a second search parameter;

obtaining, by the root server from the authorization server, one or more permitted search tokens for the second requester;

determining, by the root server, that the second token is not a permitted search token for the second requester; and

in response, declining to return predicted actions in response to the second query.

Embodiment 8 is the method of any one of embodiments 1-7, further comprising:

receiving, by the root server, a second query;

determining, by the root server, that an entry in an authorization cache corresponding to a requester of the second query is valid;

in response, obtaining, by the root server, one or more permitted action types for the requester of the second query from the authorization cache instead of from the authorization server.

Embodiment 9 is the method of embodiment 8, wherein determining, by the root server, that the entry in the authorization cache corresponding to a requester of the second query is valid comprises determining that the entry is not older than a threshold age.

Embodiment 10 is the method of embodiment 8, wherein determining, by the root server, that the entry in the authorization cache corresponding to a requester of the second query is valid comprises determining that fewer than a sampling the entry is not older than a threshold age.

Embodiment 11 is the method of any one of embodiments 1-10, further comprising:

obtaining, by the root server for the requester, a requester-specific privacy threshold; and

filtering, from the plurality of predicted actions, any actions having a respective user count that does not satisfy the requester-specific privacy threshold.

Embodiment 12 is the method of any one of embodiments 1-11, wherein the one or more predicted actions returned to the first requester include a first predicted action having a first action type and a second predicted action having a second action type, wherein the first predicted action and the second predicted action occur in a same document, and further comprising:

receiving a second query specifying the same token from a second requester;

determining that the first action type is not a permitted action type for the second requester and determining that the second action type is a permitted action type for the second requester; and

in response, providing only the second action type to the second requester.

Embodiment 13 is a system comprising: one or more computers and one or more storage devices storing instructions that are operable, when executed by the one or more computers, to cause the one or more computers to perform the method of any one of embodiments 1 to 12.

Embodiment 14 is a computer storage medium encoded with a computer program, the program comprising instructions that are operable, when executed by data processing apparatus, to cause the data processing apparatus to perform the method of any one of embodiments 1 to 12.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A computer-implemented method comprising:
receiving, from a requester by a root server of a prediction system, a query specifying a token corresponding to a search parameter, the query being a request for the prediction system to compute user actions that are most likely to co-occur in documents with the search parameter, each document comprising data representing actions performed by a single respective user during a particular time period;
obtaining, by the root server from an authorization server, one or more permitted action types for the requester;
obtaining, by the root server, a plurality of predicted actions that each co-occur in at least one document with the search parameter, including:
providing, by the root server, the token to each of a plurality of leaf servers,
searching, by each leaf server, documents assigned to the leaf server that have the search parameter corresponding to the token to determine one or more actions that co-occur with the search parameter in the documents having the search parameter, and
providing, by each leaf server to the root server, the one or more actions that co-occur in documents having the search parameter;
filtering, from the plurality of predicted actions, any actions having an action type that is not one of the one or more permitted action types for the requester; and
providing, to the requester in response to the query, one or more predicted actions having one of the permitted action types.

2. The method of claim 1, wherein obtaining, by the root server, the plurality of predicted actions that each co-occur in at least one document with the search parameter is performed at least partially concurrently with obtaining, from the authorization server, the one or more permitted action types for the requester.

3. The method of claim 1, wherein obtaining, by the root server from an authorization server, one or more permitted action types for the requester comprises:
maintaining, by the authorization server, a mapping between requester identifiers and permitted action types; and
obtaining the one or more permitted action types by using a requester identifier for the requester as input to the mapping.

4. The method of claim 3, wherein the mapping is further based on a query stream identifier that distinguishes different applications of the predicted actions for the same requester.

5. The method of claim 1, further comprising:
receiving, from a second requester by the root server, a second query specifying a requested action type;
obtaining, by the root server from the authorization server, one or more permitted action types for the second requester;
determining, by the root server, that the requested action type is not among the one or more permitted action types; and
in response, declining to return predicted actions in response to the second query.

6. The method of claim 1, further comprising:
receiving, from a second requester by the root server, a second query specifying a requested action type;
obtaining, by the root server from the authorization server, an indication that the second requester has no permitted action types; and
in response, declining to return predicted actions in response to the second query.

7. The method of claim 1, further comprising:
receiving, from a second requester by the root server, a second query specifying a second token corresponding to a second search parameter;
obtaining, by the root server from the authorization server, one or more permitted search tokens for the second requester;
determining, by the root server, that the second token is not a permitted search token for the second requester; and
in response, declining to return predicted actions in response to the second query.

8. The method of claim 1, further comprising:
receiving, by the root server, a second query;
determining, by the root server, that an entry in an authorization cache corresponding to a requester of the second query is valid;
in response, obtaining, by the root server, one or more permitted action types for the requester of the second query from the authorization cache instead of from the authorization server.

9. The method of claim 8, wherein determining, by the root server, that the entry in the authorization cache corresponding to a requester of the second query is valid comprises determining that the entry is not older than a threshold age.

10. The method of claim 8, wherein determining, by the root server, that the entry in the authorization cache corresponding to a requester of the second query is valid comprises determining that fewer than a sampling the entry is not older than a threshold age.

11. The method of claim 1, further comprising:
obtaining, by the root server for the requester, a requester-specific privacy threshold; and
filtering, from the plurality of predicted actions, any actions having a respective user count that does not satisfy the requester-specific privacy threshold.

12. The method of claim 1, wherein the one or more predicted actions returned to the first requester include a first predicted action having a first action type and a second predicted action having a second action type, wherein the first predicted action and the second predicted action occur in a same document, and further comprising:
receiving a second query specifying the same token from a second requester;
determining that the first action type is not a permitted action type for the second requester and determining that the second action type is a permitted action type for the second requester; and
in response, providing only the second action type to the second requester.

13. A prediction system comprising a root server and a plurality of leaf servers, wherein each of the root server and the plurality of leaf servers are implemented on one or more respective computers of a plurality of computers, and wherein the system further comprises one or more storage devices storing instructions that are operable, when executed by the plurality of computers implementing the root server and the plurality of leaf servers, to cause the plurality of computers to perform operations comprising:
receiving, from a requester by a root server of the prediction system, a query specifying a token corresponding to a search parameter, the query being a request for the prediction system to compute user actions that are most likely to co-occur in documents with the search parameter, each document comprising data representing actions performed by a single respective user during a particular time period;
obtaining, by the root server from an authorization server, one or more permitted action types for the requester;
obtaining, by the root server, a plurality of predicted actions that each co-occur in at least one document with the search parameter, including:
providing, by the root server, the token to each of a plurality of leaf servers,
searching, by each leaf server, documents assigned to the leaf server that have the search parameter corresponding to the token to determine one or more actions that co-occur with the search parameter in the documents having the search parameter, and
providing, by each leaf server to the root server, the one or more actions that co-occur in documents having the search parameter;
filtering, from the plurality of predicted actions, any actions having an action type that is not one of the one or more permitted action types for the requester; and
providing, to the requester in response to the query, one or more predicted actions having one of the permitted action types.

14. The system of claim 13, wherein obtaining, by the root server, the plurality of predicted actions that each co-occur in at least one document with the search parameter is performed at least partially concurrently with obtaining, from the authorization server, the one or more permitted action types for the requester.

15. The system of claim 13, wherein obtaining, by the root server from an authorization server, one or more permitted action types for the requester comprises:
maintaining, by the authorization server, a mapping between requester identifiers and permitted action types; and
obtaining the one or more permitted action types by using a requester identifier for the requester as input to the mapping.

16. The system of claim 15, wherein the mapping is further based on a query stream identifier that distinguishes different applications of the predicted actions for the same requester.

17. The system of claim 13, wherein the operations further comprise:
receiving, from a second requester by the root server, a second query specifying a requested action type;
obtaining, by the root server from the authorization server, one or more permitted action types for the second requester;
determining, by the root server, that the requested action type is not among the one or more permitted action types; and
in response, declining to return predicted actions in response to the second query.

18. The system of claim 13, wherein the operations further comprise:
receiving, from a second requester by the root server, a second query specifying a requested action type;
obtaining, by the root server from the authorization server, an indication that the second requester has no permitted action types; and
in response, declining to return predicted actions in response to the second query.

19. The system of claim 13, wherein the operations further comprise:
receiving, from a second requester by the root server, a second query specifying a second token corresponding to a second search parameter;
obtaining, by the root server from the authorization server, one or more permitted search tokens for the second requester;
determining, by the root server, that the second token is not a permitted search token for the second requester; and
in response, declining to return predicted actions in response to the second query.

20. One or more non-transitory computer storage media encoded with computer program instructions that when executed by one or more computers cause the one or more computers to perform operations comprising:
receiving, from a requester by a root server of a prediction system, a query specifying a token corresponding to a search parameter, the query being a request for the prediction system to compute user actions that are most likely to co-occur in documents with the search parameter, each document comprising data representing actions performed by a single respective user during a particular time period;
obtaining, by the root server from an authorization server, one or more permitted action types for the requester;
obtaining, by the root server, a plurality of predicted actions that each co-occur in at least one document with the search parameter, including:
providing, by the root server, the token to each of a plurality of leaf servers,
searching, by each leaf server, documents assigned to the leaf server that have the search parameter corresponding to the token to determine one or more actions that co-occur with the search parameter in the documents having the search parameter, and
providing, by each leaf server to the root server, the one or more actions that co-occur in documents having the search parameter;
filtering, from the plurality of predicted actions, any actions having an action type that is not one of the one or more permitted action types for the requester; and
providing, to the requester in response to the query, one or more predicted actions having one of the permitted action types.
